(19) United States
(12) Patent Application Publication
(10) Pub. No.: US 2009/0326126 A1
(43) Pub. Date: Dec. 31, 2009

(54) FLAME-RETARDANT RESIN COMPOSITION, PROCESS FOR PRODUCTION OF THE SAME AND PROCESS FOR MOLDING THEREOF

(76) Inventors: Takehiko Yamashita, Hyogo (JP); Kunihiko Takeda, Aichi (JP)

Correspondence Address: MCDERMOTT WILL & EMERY LLP, 600 13TH STREET, NW, WASHINGTON, DC, 20005-3096, US

(21) Appl. No.: 12/307,055

(22) PCT Filed: Jul. 3, 2007
(86) PCT No.: PCT/JP2007/063298

§ 371 Date: Apr. 21, 2009

(30) Foreign Application Priority Data
Jul. 3, 2006 (JP) 2006-183399

(51) Int. Cl. C08L 25/06; C08K 3/10; C08K 3/30

(52) U.S. Cl. 524/406; 524/420

(57) ABSTRACT

A resin composition is provided which is made flame retardant using a non-halogen flame retardancy-imparting component, and the resin composition containing HIPS as a resin component is particularly provided. A salt of succinic acid and/or a salt of malic acid or a metal sulfide is used as the flame retardancy-imparting component and this component is kneaded with the resin component such as a polystyrene polymer to produce the resin composition. Further, the resin composition is injection-molded into exterior bodies of home electric appliances. The use of molybdenum disulfide, disodium succinate or dipotassium succinate, as the flame retardancy-imparting component makes it possible to provide the resin composition of excellent flame retardancy as a non-halogen material.

### TECHNICAL FIELD

The present invention is related to a flame-retardant resin composition, particularly the resin composition containing a styrene-based resin, or a combination of styrene-based resin and a polyphenylene ether resin as a resin component, and a method for producing the resin composition and a method for molding the resin composition.

### BACKGROUND ART

A polystyrene (PS) resin has good balance between physical properties and cost and it is widely used in products in various fields, such as containers and packaging, building material, sundry goods, electric equipment and electronic equipment, fiber, paint and adhesive, automobile, and precision mechanical equipment. The total used amount of polystyrene is also large, and polystyrene is one of five general-purpose resins, along with vinyl chloride, polyethylene (PE), polypropylene (PP), and polyethylene terephthalate (PET). Not a conventional PS resin but a high-impact polystyrene (HIPS) which is obtained by blending or copolymerizing a butadiene rubber with PS is mainly used in consumer durable goods such as electric and electronic products, the building material, and the automobile among the above-mentioned applications. HIPS is further improved in impact resistance compared to PS and used for constituting parts or members, such as exterior bodies of various products which are used for a relatively long period.

PS and HIPS are often used in combination with polyphenylene ether (PPE). PPE is a kind of thermoplastic engineering resin. When PPE is used in combination with PS or HIPS, it has excellent properties, such as high heat resistance, which the engineering plastic inherently has, and is improved in mechanical properties such as impact resistance, moldability and processability, whereby the combination has balanced physical properties.

Patent Literature 1: Unexamined Japanese Patent Kokai (Laid-Open) Publication No. H10-60447 (A)

### DISCLOSURE OF INVENTION

HIPS or the mixed resin of HIPS and PPE have been used in electric appliances with a high-voltage circuit in the interior thereof, such as a television set, and have much of a record of actual use. Flame retardancy is required for exterior bodies of the electric appliances with high-voltage circuit in order that safety is ensured. Further, more importance is attached to the safety of recent electric appliances, which creates the tendency to employ the flame-retardant resin in appliances which do not include high-voltage elements.

The flame retardation of HIPS is made by blending a halogen-based flame retarder and an auxiliary agent for flame retarder with HIPS, and these flame retarders and auxiliary agent for flame retarder allow the HIPS to have high flame retardancy. However, there is concern that the resin containing the halogen-based flame retarder may generate dioxin when it is disposed and incinerated. For this concern, the use of the halogen-based flame retarders is now being prohibited in Europe.

The use of the halogen-based flame retarder is being prohibited not only for the PS resin, but also for other general-purpose resins. For this reason, non-halogen-based flame retarder which confers high frame retardancy to the resin is required and being developed.

For example, a phosphorus-based flame retarder is known as the non-halogen-based flame retardant. The phosphors-based flame retarder shows high flame retardancy to some extent, but it is required to be mixed with the resin at a high mixing ratio (for example, in an amount of from 10 wt % to 50 wt % of the resin composition) so as to achieve the same flame retardancy as that of the halogen-based flame retardant. For this reason, the resin composition which contains the phosphorus-based flame retarder tends to be inferior in mechanical properties. Further, there is concern for effect of the phosphorus-based flame retarder on the human body due to resemblance of a part of structure of the retarder to an insecticide. Furthermore, there is concern for effect on environment by lake eutrophication which is caused by leakage of phosphorus. These concerns have created a move to study these effects.

In addition, also a non-formalin flame retarder is required due to concern for effect of formalin on the environment. For example, Patent Literature 1 proposes a non-formalin flame retarder of an aqueous solution or an aqueous dispersion, wherein a guanidinium salt as an inorganic acid salt and a water-soluble polymer are combined. This flame retarder is, however, used by being applied to a cellulose material and is not suitable for being added to and kneaded with PS or the like, since it is the aqueous solution or the aqueous dispersion.

As described in the above, a material which gives less effect on the environment and the human body is recently required, and this tendency is seen for substances which are added to the resin. The present invention has been made in the light of these situations. The object of the present invention is to provide a resin composition which is sufficiently flame-retarded using a non-halogen or non-phosphorus flame retarder without changing the physical properties of the resin significantly.

The present inventors have found that when either or both of a salt of succinic acid and a salt of malic acid, or a metal sulfide is added to a general-purpose resin, particularly a styrene-based polymer or a mixed resin containing styrene-based polymer, more particularly a mixed resin of PS and PPE and a mixed resin HIPS and PPE (hereinafter, these mixed resins are referred to as “PS/PPE” and “HIPS/PPE” respectively by using “/”), high flame retardancy is imparted to the resin with not much amount of the flame retarder, resulting in the present invention.

In a first aspect, the present invention provides a resin composition which contains one or more resin components and either or both of a salt of succinic acid and a salt of malic acid as a flame retardancy-imparting component.

Herein, the term “resin” is used for referring to a polymer in the resin composition, and a term “resin composition” is used for referring to a composition containing at least the resin. A term “plastic” is used for referring to a substance which contains the polymer as an essential component. The resin composition of the present invention can be called as plastic since it contains the resin component and the flame retardancy-imparting component.

“Flame retardancy” means property of not continuing combustion or not generating afterglow after removing an ignition source. The “flame retardancy-imparting component” which imparts flame retardancy, includes a flame-retardant component which makes the resin to be flame-retarded one when the component is added to the resin (such component may be called as a “flame retarder”), and an auxiliary agent for flame retarder which cannot make the resin to be flame-retarded one alone, but enhances the effect of improving flame retardancy exerted by the flame-retardant component, when the agent is added together with the flame-retardant component. Thus, the “flame retardancy-imparting component” generically refers to components which contribute to improvement of flame retardancy of the resin.

Succinic acid is represented by HOOC(CH₂)₂COOH. Malic acid is also called as “hydroxysuccinic acid” and represented by HOOCCH₂CH(OH)COOH. Each of the salts of these acids is a compound wherein two carboxyl groups and cations forms a structure represented by —COO⁻M⁺. In the resin composition of the present invention, an alkaline metal salt of succinic acid is preferably used, and either or both of disodium succinate and dipotassium succinate are more preferably used.

It is preferable that the resin composition contains a styrene-based polymer as the resin component, and it is more preferable that the resin composition contains polyphenylene ether in addition to the styrene-based polymer. In the case where the styrene-based polymer is contained as at least one resin component, the polymer is preferably a high-impact polystyrene. The salts of succinic acid and malic acid show high flame-retardancy especially for the styrene-based polymer and the combination of the styrene-based polymer (particularly the high-impact polystyrene) and polyphenylene ether.

In a second aspect, the present invention provides a resin composition which contains one or more resin components and one or more metal sulfides as a flame retardancy-imparting component. The metal sulfide is preferably one or more metal sulfides selected from sulfides of molybdenum, nickel, zinc and cobalt, and more preferably molybdenum disulfide (MoS₂).

Also in the resin composition which contains the metal sulfide as the flame retardancy-imparting component, it is preferable that polystyrene is contained as the resin component, and it is more preferable that polystyrene and polyphenylene ether are contained. In the case where polystyrene is contained as at least one resin component, polystyrene is preferably a high-impact polystyrene.

The present invention also provides a method for producing a flame-retardant resin composition, which includes kneading one or more resin components and one or more flame retardancy-imparting components, wherein at least one of the flame retardancy-imparting components is a salt of succinic acid, a salt of malic acid or a metal sulfide. In this production method, the flame retardancy-imparting component is added to the resin component in a kneading step wherein the resin is melted. The kneading step is an essential step in a general plastic production process or a molding process. Therefore, another step of blending the flame retardancy-imparting component is not required in this production method, and the flame-retardant resin composition may be obtained without raising the production cost so much.

Further, the present invention provides a method for molding a flame-retardant resin composition which method includes molding a composition which is obtained by kneading one or more resin components and one or more flame retardancy-imparting components, according to an injection molding method or a compression molding method, wherein the flame retardancy-imparting component is a salt of succinic acid, a salt of malic acid or a metal sulfide. That is, the flame-retardant resin composition may be molded according to a conventional method without substantially changing a conventional production apparatus for a plastic molded article.

This molding method may be applied to any of the resin components. Therefore, when the polystyrene-based polymer (such as PS and HIPS) or the mixture of the polystyrene-based polymer and PPE (such as PS/PPE or HIPS/PPE) is contained as the resin component in the resin composition of the present invention, it may be molded using a conventional apparatus for such polymers as is.

### EFFECT OF INVENTION

The present invention makes it possible to confer the flame retardancy, using the flame retardancy-imparting component which is a non-halogen and non-phosphorus flame retardancy-imparting component, to the general-purpose resins (particularly the styrene-based polymer and the mixture of the styrene-based polymer and another resin, and more particularly PS, HIPS, PS/PPE or HIPS/PPE) which are used in various articles, without increasing production steps. Further, the resin composition of the present invention may be a very earth-conscious material since the composition generates no or small amount of harmful substances even if it is incinerated after use. Furthermore, the resin composition of the present invention has high industrial value and is useful since it has high flame retardancy and can be used as the exterior bodies of the electric appliances. In addition, the salt of succinic acid, the salt of malic acid and the metal sulfide are used, as the flame retardancy-imparting component, advantageously from the viewpoint of cost since any of these compounds is cheaper than the halogen-based flame retarder.

### BRIEF DESCRIPTION OF DRAWINGS

FIG. 1 is a flow chart showing a method for producing a flame-retardant resin composition of the present invention.

### BEST MODE FOR CARRYING OUT THE INVENTION

As described in the above, the resin composition of the present invention contains one or more resin components and either or both of a salt of succinic acid and a salt of malic acid, or a metal sulfide as a flame retardancy-imparting component. Firstly, the resin component is described.

A preferred embodiment of the resin composition of the present invention contains a styrene-based polymer as the resin component. The styrene-based polymer is a polymer (which includes a copolymer) whose monomer component is styrene or a modified styrene. The styrene-based polymers include polystyrene (PS), a styrene/butadiene copolymer (SBR), a hydrogenated styrene/butadiene copolymer (HSBR), a styrene/ethylene-butylene copolymer (SEBR), a styrene/isoprene copolymer (SIR), a styrene-acrylonitrile copolymer (AS) and an acrylonitrile-butadiene-styrene copolymer (ABS).

The styrene-based polymers which are represented by polystyrene have been widely used in various articles. Therefore, the harmful substances which are produced during the incineration of the polymer are eliminated or reduced, if these polymers are flame-retarded by the flame retarder which is substantially non-halogen or non-phosphorus one. Thus, the present invention can provide an environmentally-friendly resin composition to the extent that the flame retarder is a non-halogen and non-phosphorus one.

When the resin composition is used for an exterior body that requires impact resistance, the resin component is preferably a mixture wherein a rubber resin is added to polystyrene, or a two-component copolymer of a rubber and styrene. These mixture and copolymer are referred to as a “high-impact polystyrene” (HIPS). One or more resins selected from, for example, butadiene, a silicone-based rubber and an acryl-based rubber are added to or copolymerized with polystyrene. The butadien-based rubber is preferably added or copolymerized. The rubber resin such as the butadiene rubber preferably occupies 5 wt % to 45 wt % of the entire mixture or the entire copolymer. This mixing or copolymerization ratio effectively increases the impact resistance of the resin.

Alternatively, the styrene-based polymer may be mixed with polyphenylene ether (PPE) which is a thermoplastic engineering plastic. PPE has high heat resistance and extremely high size stability. In the case where PPE is used in combination with the styrene-based polymer (especially PS), the resin composition can have good moldability and processability with the feature of styrene maintained. In particular, PPE is preferably used in combination with HIPS. The use of the mixed resin of HIPS and PPE is particularly preferable since the mixed resin also has the high impact resistance which is given by HIPS. When the styrene-based polymer and PPE are mixed, PPE is preferably mixed in an amount of 30 wt % to 90 wt % of the total amount of the styrene-based polymer and PPE, and more preferably in an amount of 45 wt % to 75 wt %. If the ratio of PPE is small, the characteristic property of PPE, such as the heat resistance and the size stability, cannot be realized in the resin. If the ratio of PPE is too large, a molding temperature is required to be close to 300° C., which deteriorates the moldability. These are applicable to the case wherein HIPS and PPE are mixed.

Another preferred embodiment contains a polyester resin such as polyethylene terephthalate (PET), a modified polyethylene terephthalate, and a polybutylene terephthalate (PBT). The polyester resin is widely used in various articles similarly to the styrene-based resin, and the utility value of the resin is increased when it is flame-retarded by the non-halogen- and non-phosphorus-based flame retarder. Further, some types of the modified polyethylene terephthalate (for example, a copolymer) has biodegradability (that is, it can be degraded into low-molecular-weight molecules with microorganism participation in nature, and finally degraded into water and oxygen). Therefore, when such biodegradable resin is used, the resin composition of the present invention is very environmentally-friendly one which has biodegradability and be flame-retarded by the non-halogen and the non-phosphorus flame retarder.

In still another embodiment of the present invention, the resin component constituting the resin composition of the present invention may be a resin component which is other than those exemplified in the above. Specifically, one or more resins selected from:
1) thermoplastic resins such as polyethylene, polypropylene, an ethylene-vinyl acetate copolymer and polyvinyl chloride;
2) thermoplastic elastomers such as a butadiene rubber (BR) and an isoprene rubber (IR);
3) thermoplastic engineering resins such as polyamide (PA) and polycarbonate (PC);
4) super engineering resins such as polyarylate and polyetheretherketone (PEEK); and
5) thermosetting resins such as an epoxy resin (EP), a vinyl ester resin (VE), polyimide (PI) and polyurethane (PU) may be contained as the resin component in the resin composition of the present invention.

Alternatively, the resin component may be a biodegradable resin other than the modified polyethylene terephthalate resins, or may be a plant-based resin obtained by polymerizing or copolymerizing monomers which are obtained from plant materials. The biodegradable resins include, for example, polycaprolactone (PCL), polybutylene succinate (PBS; a copolymer resin of 1,4-butanediol and succinic acid), polyhydroxybutyric acid (PHB) which is produced by a microorganism. The plant-based resins include, for example, polylactic acid (PLA), a lactic acid copolymer and polybutylene succinate (PBS).

Next, the flame retardancy-imparting component which confers the flame retardancy is described. As described in the above, either or both of the salt of succinic acid and the salt of malic acid (in this specification including the following description, this expression may be replaced with the expression “the salt of succinic acid and/or the salt of malic acid”), or the metal sulfide is used. Firstly, the salt of succinic acid and the salt of malic acid are described.

The salts of succinic acid and malic acid are metal salts, an ammonium salt and so on. The metal salts include, for example, salts of alkaline metals such as lithium, sodium, and potassium, salts of alkaline earth metals, such as calcium and barium, and salts of other metals such as magnesium and zinc. The salts of succinic acid and malic acid are preferably used since they give excellent flame retardancy to a styrene-based polymer (particularly, PS and HIPS) and a mixture of the styrene-based polymer and PPE (particularly, PS/PPE and HIPS/PPE). Disodium succinate and dipotassium succinate are preferably used as the salt of succinic acid, and disodium succinate is particularl dey preferably used. The same is applicable to malic acid. This is because these salts particularly develop high flame retardancy, among the alkaline metal salts.

In the resin composition of the present invention, two or more salts selected from the above-mentioned salts may be contained. For example, a succinate and a malate which have the same metal may be contained. Alternatively, two or more salts may be contained, wherein the respective salts are composed of a common acid and the respective different cations.

In an another embodiment, a combination of the salt of succinic acid and/or the salt of malic acid and a known general flame retarder may be contained as the flame retardancy-imparting component. In that case, an effect that an amount of the known flame retarder is reduced, is obtained. Specifically, when, for example, the salt of succinic acid and/or the salt of malic acid and a phosphorus-based flame retarder are used in combination and the salt of succinic acid and/or the salt of malic acid is added in an amount of 3 wt % to 10 wt % (particularly, for example, 5 wt %) and the phosphorous-based flame retardant is added in an amount of 12 wt % to 5 wt % (particularly, for example, about 10 wt %) of the resin composition, the resultant resin composition has the same flame retardancy as that of the composition wherein only the phosphorus-based flame retarder is contained in an amount of about 40 wt %. Therefore, the present invention makes it possible to give the resin composition of high flame retardancy because of the use of the salt of succinic acid and/or the salt of malic acid as the flame retardancy-imparting component, even if the mixing ratio of the known flame retarder is reduced. This fact reduces the load to the environment than in the past, even if the halogen-based or the phosphorus-based flame retarder cannot be completely eliminated.

The known flame retarders include, for example, a phosphorus-based flame retarder, a halogen-based flame retarder, and a metal hydroxide-based flame retarder. The metal hydroxide-based flame retarders are, for example, magnesium hydroxide (Mg(OH)₂), and aluminum hydroxide ((Al(OH)₃). When the metal hydroxide-based flame retarder is mixed with the resin composition, the rigidity of the molded body is increased. Therefore, the metal hydroxide-based flame retarder is preferably used when the strength and the rigidity of the molded body (for example, a back cover for a television receiver) is desired to be large.

Alternatively, a substance which is selected from molybdenum oxide, tri-cobalt tetra-oxide (Co₃O₄), polyphenol, and a zeolite catalyst may be added together with the salt of succinic acid and the salt of malic acid. These substances give the flame retardancy to the resin composition.

In another embodiment, a salt of another acid may be used as the flame retardancy-imparting component in place of the salt of succinic acid and/or the salt of malic acid. The salts of other acids include, for example, potassium formate, potassium acetate and sodium acetate, zinc borate and sodium borate, potassium aluminate trihydrate and sodium aluminate, and sodium laurate and potassium laurate.

Next, the metal sulfide is described. The metal sulfide is preferable flame retardancy-imparting component since it gives less bleed out and can exist in the resin composition stably because it is not soluble in water. Further, since the metal sulfide has a very small particle diameter (about 2 μm), it shows excellent dispersibility in the resin. Further, the metal sulfide makes it possible to color the resin composition black without using a black pigment or a black dye because the metal sulfide is a dark black. There are many compounds composed of various metal elements and sulfide, as the metal sulfide. Further, one metal element gives two or more sulfides with different oxidation numbers.

Specifically, the metal sulfide is selected from nickel sulfide, zinc sulfide, cobalt sulfide, molybdenum sulfide, antimony sulfide, potassium sulfide, calcium sulfide, gold sulfide, silver sulfide, germanium sulfide, sodium sulfide, tin sulfide, niobium sulfide, copper sulfide, strontium sulfide, tantalum sulfide, iron sulfide, vanadium sulfide and manganese sulfide. The resin composition of the present invention preferably contains the metal sulfide selected from molybdenum disulfide, nickel sulfide, zinc sulfide and cobalt sulfide. These sulfides are preferably used since they give excellent flame retardancy to the styrene-based polymer (particularly, PS and HIPS), and the mixture of the styrene-based polymer and PPE (particularly, PS/PPE and HIPS/PPE). The resin composition of the present invention particularly preferably contains molybdenum disulfide as the metal sulfide.

The resin composition of the present invention may contain two or more metal sulfides which are exemplified in the above. For example, two or more sulfides which are composed of different metals may be used, or two or more metal sulfides which are composed of the same metal having different oxidation numbers. Alternatively, in another embodiment, a combination of the metal sulfide and a known general flame retarder may be contained as the flame retardancy-imparting component. In that case, the metal sulfide may be contained in an amount of 3 wt % to 10 wt % and the known flame retarder may be contained in an amount of 12 wt % to 5 wt %, based on the resin composition. The known flame retarder is as described in the above in connection with the salt of succinic acid and/or the salt of malic acid. Further, the effect of the combination of the known flame retarder and the metal sulfide is as described in connection with the salt of succinic acid and/or the salt of malic acid. Further, molybdenum oxide may be used in combination with the metal sulfide, as described in connection with the salt of succinic acid and/or the salt of malic acid.

The additive amount (the ratio occupying the resin composition) of the salt of succinic acid and/or the salt of malic acid or the metal sulfide depends on the type of the flame retardancy-imparting component, the type of the resin component, and the degree of the flame retardancy required for the resin composition and the change of physical property of the resin composition due to the addition of the flame retardancy-imparting component. Specifically, the salt of succinic acid and/or the salt of malic acid or the metal sulfide preferably occupies about 0.5 wt % to about 40 wt % of the resin composition, and more preferably about 5 wt % to about 30 wt %. When the ratio of the salt of succinic acid and/or the salt of malic acid or the metal sulfide is less than 0.5 wt %, the flame retardancy is difficult to be improved significantly. When the ratio is over 40 wt %, undesirable effect (for example, defective moldability caused by diminished fluidity) due to the mixing of the flame retardancy-imparting component is pronounced. When a flame retardancy-imparting component other than the salt of succinic acid and/or the salt of malic acid and the metal sulfide is used, the total ratio of the flame retardancy-imparting components is preferably within the above-mentioned range. In that case, the salt of succinic acid and/or the salt of malic acid or the metal sulfide preferably occupies 0.5 wt % or more of the resin composition so that the effect of the present invention is obtained.

The salt of succinic acid and/or the salt of malic acid or the metal sulfide, as the flame retardancy-imparting component, preferably has a particle diameter of about 0.001 μm to about 1000 μm (when it is not sphere, a length of the longest line segment among the segments connecting two arbitrarily-selected points on the surface of the particle is preferably within this range). These flame retardancy-imparting components show higher flame retardant effect when these are mixed, in a form of finer particles, with the resin component. Therefore, if desired flame retardancy should be obtained, the additive amount may be smaller as the particles are finer. If, however, the particle diameter is too small, the particles form a large one by aggregation. On the other hand, the particle diameter is too large, the flame retardancy-imparting function is exerted to the resin more weakly, because the distance between the particles is large, resulting in combustible portions in the resin composition. This allows the combustible portion to start to conflagrate and then the flame to spread the entire resin, which may results in uncontrolled combustion.

The salt of succinic acid and/or the salt of malic acid or the metal sulfide as the flame retardancy-imparting component may be preferably dispersed in the resin with the component supported on an inorganic porous material. Specifically, the flame retardancy-imparting component is preferably dispersed in the resin by a method wherein the flame retardancy-imparting component is supported on the inorganic porous material followed by being kneaded with the resin component so that the inorganic porous material is crushed into fine particles and dispersed in the resin. The combination with the inorganic porous material gives the resin composition wherein the flame retardancy-imparting component is more evenly dispersed, whereby the additive amount of the flame retardancy-imparting component is more reduced. In other words, in the case where the inorganic porous material is employed, granules which are large enough not to aggregate are added at the beginning of kneading and then they are crushed into fine particles during the kneading to be dispersed evenly, which results in improvement in dispersibility of the flame retardancy-imparting component compared with the case of adding the flame retardancy-imparting component alone. Further, the inorganic porous material improves the flame retardancy of the resin composition synergistically with the supported flame retardancy-imparting component, since the material itself has a characteristic of conferring flame retardancy to the resin.

The inorganic porous material is a porous material formed from silicon oxide and/or aluminum oxide, which has pores of which diameter is from 10 nm to 50 nm at a ratio of 45 vol % to 55 vol %. Such an inorganic porous material is preferably a granular material which has a diameter of from 100 nm to 1000 nm when the flame retardancy-imparting component is supported. When the granular diameter is too small, aggregation may occur to give giant particles. On the other hand, when the granular diameter is too large, the granular diameter of the inorganic porous material after being crushed in the kneading step may be large not to be dispersed evenly. The inorganic porous material preferably has a granular diameter of from 25 nm to 150 nm in the final resin composition (that is, after kneading the inorganic porous material). In the case where the inorganic porous material is used, the flame retardancy-imparting component may be supported at a ratio of 3 parts to 50 parts by weight, on the inorganic porous material of 100 parts by weight. The inorganic porous material which supports the flame retardancy-imparting component at such a ratio may be added and kneaded so that the material occupies, for example, 1 wt % to 40 wt % of the entire resin composition. The amount of the flame retardancy-imparting component to be supported and the additive amount of the inorganic porous material are illustrative, and they may be outside these ranges depending on the type of the flame retardancy-imparting component.

The flame retardancy-imparting component may be supported on the inorganic porous material by a method wherein the inorganic porous material is immersed in a liquid in which the flame retardancy-imparting component to be supported is dissolved or dispersed in a solvent, and then the solvent is evaporated by heating. The inorganic porous material itself can be produced by a known method. For example, the material may be obtained by a technique of dissolving a pore-forming agent (for example, a water soluble inorganic salt) in a silica sol and sintering a dried sol followed by dissolving the pore-forming agent into hot water to remove the agent from resultant particles. Alternatively, the inorganic porous material may be a porous glass or a zeolite.

A specific example is described wherein HIPS/PPE is selected as the resin component and disodium succinate is selected as the flame retardancy-imparting component. In this case, it is preferable to employ, as the inorganic porous material, a porous material formed from silicon oxide (silica) containing pores with a pore diameter of from 10 nm to 50 nm at a ratio of 45 vol % to 55 vol %, in a form of granules having a granular diameter of from 100 nm to 1000 nm. Disodium succinate is preferably supported on the silica porous material at a ratio of 5 parts to 50 parts by weight on the silica porous material of 100 parts by weight, and more preferably at a ratio of 10 parts to 45 parts by weight. The silica porous material supporting disodium succinate is preferably added so as to occupy 5 wt % to 40 wt % of the entire resin composition, and more preferably 5 wt % to 15 wt %. The inorganic porous material is dispersed as fine particles having particle diameters of from 25 nm to 150 nm, and disodium succinate is mixed at a ratio of about 0.24 wt % to about 13.3 wt %, preferably at a ratio of about 0.45 wt % to about 4.7 wt %, in the resin composition which is obtained by adding this inorganic porous material followed by kneading. The use of the inorganic porous material makes it possible to reduce the additive ratio of the flame retardancy-imparting component.

Another specific example is described wherein HIPS/PPE is selected as the resin component and molybdenum disulfide is selected as the flame retardancy-imparting component. In this case, it is preferable to employ, as the inorganic porous material, a porous material formed from silicon oxide (silica) containing pores with a pore diameter of from 10 nm to 50 nm at a ratio of 45 vol % to 55 vol %, in a form of granules having a granular diameter of from 100 nm to 1000 nm. Molybdenum disulfide is preferably supported at a ratio of 5 parts to 40 parts by weight on the silica porous material of 100 parts by weight, and more preferably at a ratio of 10 parts to 20 parts by weight. The silica porous material supporting molybdenum disulfide is preferably added so as to occupy 5 wt % to 40 wt % of the entire resin composition, and more preferably 5 wt % to 15 wt %. The inorganic porous material is dispersed as fine particles having particle diameters of from 25 nm to 150 nm, and molybdenum disulfide is mixed at a ratio of about 0.25 wt % to about 16 wt %, preferably at a ratio of about 0.5 wt % to about 3 wt %, in the resin composition which is obtained by adding this inorganic porous material followed by kneading. The use of the inorganic porous material makes it possible to reduce the additive ratio of the flame retardancy-imparting component.

The resin composition of the present invention may contain an auxiliary agent for flame retarder in addition to the above-mentioned flame retardancy-imparting component. The auxiliary agent for flame retarder cannot serve as the flame retarder by itself, but enhances the flame retardation effect exerted by the flame-retardant component, when the agent is added together with the flame-retardant component. Therefore, the use of the auxiliary agent for flame retarder enables the additive amount of the flame-retardant component to be further reduced. As the auxiliary agent for flame retarder, for example, one or more compounds may be used, which compound(s) is selected from an organic peroxide, such as a ketone peroxide, a peroxy ketal, a hydroperoxide, and a dialkyl peroxide, a peroxy ester and a peroxydicarbonate; a dimethyl-diphenyl butane; and a derivative of these compounds.

When the organic peroxide is used as the auxiliary agent for flame retarder, it is presumed that the organic peroxide releases oxygen in the resin composition whereby the flame retardancy of the resin composition is improved. When the dimethyl-diphenyl butane is used as the auxiliary agent for flame retarder, it is presumed that the dimethyl-diphenyl butane exerts a radical trap effect whereby the flame retardancy of the resin composition is improved. These presumptions, however, do not affect the scope of the present invention. When a plurality of compounds are used, the mixing ratio of the compounds is not limited to a particular one, and it is selected so that desired flame retardant property is achieved.

The auxiliary agent for flame retarder may be added in an amount of 5 parts to 45 parts by weight to the flame-retarder of 100 parts by weight, depending on the type and the added amount of the flame-retardant component. Further, the total amount of the auxiliary agent for flame retarder and the flame-retardant component (that is, the amount of the flame retardancy-imparting component) preferably corresponds to an amount of 5 wt % to 40 wt % of the entire resin composition. The reason therefor is as described in connection with the flame retardancy-imparting component.

The resin composition of the present invention may contain another component in addition to the above-described components (that is, the resin component, the flame retardancy-imparting component (including the inorganic porous material in the case where the flame-retardancy-imparting component is supported on the material). For example, a colorant may be contained so that the color of the resin composition is a desired one. Further, for the purpose of achieving the desired physical property of the resin composition, a butadiene rubber, for example, may be included in order to improve impact resistance as described above. The impact resistance may be improved when the resin composition further includes an acrylic rubber and/or a silicon rubber.

The resin composition of the present invention is produced by kneading the resin component and the flame retardancy-imparting component. The kneading may be carried out before forming pellets, when the pellet-shaped resin composition is produced. Alternatively, a pellet-shaped resin (or resin composition) may be kneaded with the flame retardancy-imparting component, and then formed into a pellet shape again. Alternatively, the flame retardancy-imparting component may be mixed, during a molding step, with a melted resin that does not contain the flame retardancy-imparting component. When exterior bodies of electric appliances are produced by molding a plastic, an injection molding method wherein the resin is melted and injection-molded in a metallic mold of a desired shape, or a compression molding method wherein the resin is melted and a pressure is applied with an upper mold and a lower mold, is generally employed. In these molding methods, a step of kneading the melted resin with a kneader is carried out. Therefore, the flame retardancy-imparting component is mixed with the resin component upon the kneading, to give a molded body formed from the flame-retardant resin composition. Since such addition of the flame retardancy-imparting component does not require another step of adding the flame retardancy-imparting component, the resin composition of the present invention is efficiently produced.

The resin composition of the present invention is obtained by using, as the flame retardancy-imparting component, the compound which does not substantially contain halogen or phosphorus so as to confer flame retardancy to the resin, preferably the styrene-based polymers such as PS or HIPS, and the mixed resin containing the styrene-based polymer such as PS/PPE or HIPS/PPE. The resin composition of the present invention is preferably used in a form of molded body, for packages or parts of various electric appliances. Specifically, the resin composition of the present invention may be used as members for the packages and the parts of a computer, a cellular phone, audio products (such as a radio, a cassette deck, a CD player, and an MD player), a microphone, a keyboard, and a portable audio player. Alternatively, the resin composition of the present invention may be used for an interior material of a car, an exterior material of a two-wheel vehicle, and various miscellaneous household goods.

### Examples

### (Test 1)

High-impact polystyrene (HIPS) of 50 wt % and polyphenylene ether (PPE) of 50 wt % were heated to melt and kneaded with a twin screw kneader and pellets were produced (Step 1). In this test, disodium succinate powder as the flame-retardant component was kneaded together with the PS/PPE pellets obtained in Step 1, and a mixing ratio of disodium succinate was determined which ratio was necessary for obtaining a flame-retardant resin composition which satisfied V0 according to the UL specification.

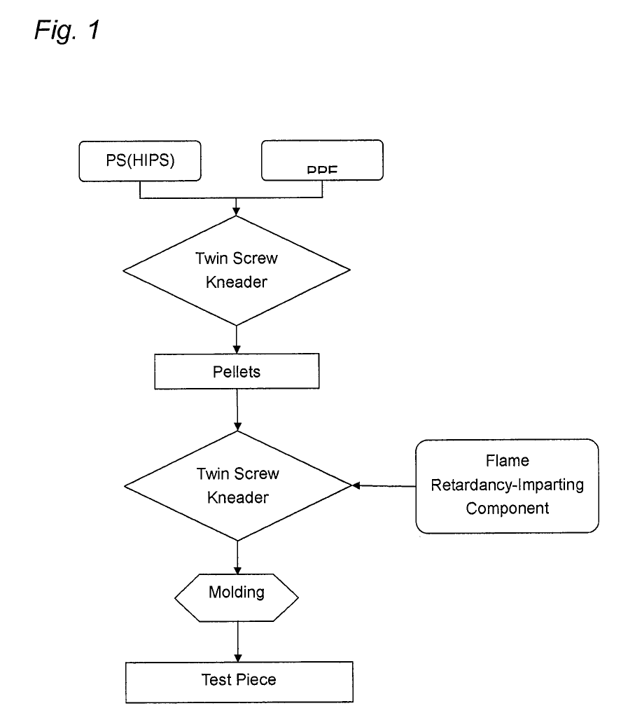

A blending sequence for the composition in this test is illustrated by a flow chart shown in FIG. 1. In this test, the pellets obtained in Step 1 and disodium succinate, as the flame-retardant component, which was previously activated by heating treatment were kneaded with the twin screw kneader at 245° C. (Step 2), and press-molded into a test piece of 125 mm×13 mm×3.2 mm (at a molding temperature of 245° C. under a pressure of 120 kg/cm²) (Step 3). In this test, a plurality of test pieces were produced varying the mixing ratio of disodium succinate to the pellet and each piece was evaluated as to flame retardancy. Disodium succinate was used in a form of powder having particle diameters of about 0.1 μm to 100 μm. The powder was not crushed by kneading and the powder retaining the initial size was dispersed in the resin. As a result of evaluation, the mixing ratio of PS/PPE pellet to disodium succinate was required to be 90:10 (weight ratio) in order to achieve the flame retardancy V0 according to the UL specification. The results of the UL-94 vertical flame test for the test piece having this mixing ratio are shown as the results of Test 1 in Table 1.

### (Test 2)

High-impact polystyrene (HIPS) of 30 wt % and polyphenylene ether (PPE) of 70 wt % were heated to melt and kneaded with a twin screw kneader and pellets were produced (Step 1). Disodium succinate powder as the flame-retardant component component was kneaded together with the PS/PPE pellets obtained in Step 1, and a mixing ratio of disodium succinate was determined which ratio was necessary for obtaining a flame-retardant resin composition which satisfied V0 according to the UL specification.

A blending sequence for the composition in this test is illustrated by a flow chart shown in FIG. 1. In this test, the pellets obtained in Step 1 and disodium succinate, as the flame-retardant component, which was previously activated by heating treatment were kneaded with the twin screw kneader at 245° C. (Step 2), and press-molded into a test piece of 125 mm×13 mm×3.2 mm (at a molding temperature of 245° C. under a pressure of 120 kg/cm²) (Step 3). In this test, a plurality of test pieces were produced varying the mixing ratio of disodium succinate to the pellet and each piece was evaluated as to flame retardancy. Disodium succinate was used in a form of powder having particle diameters of about 0.1 μm to 800 μm. The powder was not crushed by kneading and the powder retaining the initial size was dispersed in the resin. As a result of evaluation, the mixing ratio of PS/PPE pellet to disodium succinate was required to be 93:7 (weight ratio) in order to achieve the flame retardancy V0 according to the UL specification. The results of the UL-94 vertical flame test for the test piece having this mixing ratio are shown as the results of Test 2 in Table 1.

### (Test 3)

MoS₂ powder as the flame-retardant component was kneaded together with the pellets obtained in Step 1 of Test 1 and a mixing ratio of MoS₂ was determined which ratio was necessary for obtaining a flame-retardant resin composition which satisfied V0 according to the UL specification. A blending sequence for the composition in this test is illustrated by a flow chart shown in FIG. 1, similarly to Test 1.

In this test, the pellets obtained in Step 1 and MoS₂, as the flame-retardant component, which was previously activated by heating treatment were kneaded with the twin screw kneader at 245° C. (Step 2), and press-molded into a test piece of 125 mm×13 mm×3.2 mm (at a molding temperature of 245° C. under a pressure of 120 kg/cm²) (Step 3). In this test, a plurality of test pieces were produced varying the mixing ratio of MoS₂ to the pellet and each piece was evaluated as to flame retardancy. MoS₂ was used in a form of powder having particle diameters of about 1 μm to 1300 μm. The powder was not crushed by kneading and the powder retaining the initial size was dispersed in the resin. As a result of evaluation, the mixing ratio of PS/PPE pellet to MoS₂ was required to be 89:11 (weight ratio) in order to achieve the flame retardancy V0 according to the UL specification. The results of the UL-94 vertical flame test for the test piece having this mixing ratio are shown as the results of Test 3 in Table 1.

### (Test 4)

Dipotassium succinate powder as the flame-retardant component was kneaded together with the pellets obtained in Step 1 of Test 1 and a mixing ratio of dipotassium succinate was determined which ratio was necessary for obtaining a flame-retardant resin composition which satisfied V0 according to the UL specification. A blending sequence for the composition in this test is illustrated by a flow chart shown in FIG. 1, similarly to Test 1.

In this test, the pellets obtained in Step 1 and dipotassium succinate, as the flame-retardant component, which was previously activated by heating treatment were kneaded with the twin screw kneader at 245° C. (Step 2), and press-molded into a test piece of 125 mm×13 mm×3.2 mm (at a molding temperature of 245° C. under a pressure of 120 kg/cm²) (Step 3).

In this test, a plurality of test pieces were produced varying the mixing ratio of dipotassium succinate to the pellet and each piece was evaluated as to flame retardancy. Dipotassium succinate was used in a form of powder having particle diameters of about 0.5 μm to 900 μm. The powder was not crushed by kneading and the powder retaining the initial size was dispersed in the resin. As a result of evaluation, the mixing ratio of PS/PPE pellet to dipotassium succinate was required to be 88:12 (weight ratio) in order to achieve the flame retardancy V0 according to the UL specification. The results of the UL-94 vertical flame test for the test piece having this mixing ratio are shown as the results of Test 4 in Table 1.

### (Test 5)

In this test, the pellets obtained in Step 1 of Test 1 was used. A blending sequence for the composition in this test is illustrated by a flow chart shown in FIG. 1, similarly to Test 1. In this test, disodium succinate of 40 parts by weight, as the flame-retardant component, was supported on SiO₂ porous material of 100 parts by weight. The pellets of 90 wt % which was obtained in Step 1 and the SiO₂ porous material supporting disodium succinate of 10 wt % were kneaded at 245° C. (Step 2) and press-molded into a test piece of 125 mm×13 mm×3.2 mm (at a molding temperature of 245° C. under a pressure of 120 kg/cm²) (Step 3).

The SiO₂ porous material used in this test had a porosity of about 45 vol % to about 50 vol %, and a granular diameter of about 100 nm to about 1000 nm. This SiO₂ porous material was crushed by a shearing force when being kneaded with the resin, and finally dispersed as finer particles which had particle diameters of about 25 nm to about 150 nm (a mean particle diameter of about 75 nm) in the resin. The content of disodium succinate in the resin composition was calculated to be 4 wt %. The test piece obtained was subjected to the UL-94 vertical flame test similarly to Test 1. The results are shown as the results of Test 5 in Table 1.

### (Test 6)

Polystyrene (PS) pellets and disodium succinate, as the flame-retardant component, were kneaded and a mixing ratio of disodium succinate was determined which ratio was necessary for obtaining a flame-retardant resin composition which satisfied V0 according to the UL specification.

A blending sequence for the composition in this test is illustrated by a flow chart wherein the pellets indicated in the middle of FIG. 1 is replaced with PS. In this test, the PS pellets and disodium succinate, as the flame-retardant component, which was previously activated by heating treatment were kneaded with the twin screw kneader at 245° C. (Step 2), and press-molded into a test piece of 125 mm×13 mm×3.2 mm (at a molding temperature of 245° C. under a pressure of 120 kg/cm²) (Step 3). In this test, a plurality of test pieces were produced varying the mixing ratio of disodium succinate to the PS pellet and each piece was evaluated as to flame retardancy. Disodium succinate was used in a form of powder having particle diameters of about 0.1 μm to about 800 μm. The powder was not crushed by kneading and the powder retaining the initial size was dispersed in the resin. As a result of evaluation, the mixing ratio of PS pellet to disodium succinate was required to be 75:25 (weight ratio) in order to achieve the flame retardancy V0 according to the UL specification. The results of the UL-94 vertical flame test for the test piece having this mixing ratio are shown as the results of Test 6 in Table 1.

TABLE 1

| Item | Test 1 | Test 2 | Test 3 | Test 4 | Test 5 | Test 6 |
|---|---|---|---|---|---|---|
| Afterflame time | 8 sec | 7 sec | 9 sec | 9 sec | 8 sec | 9 sec |
| Total afterflame time | 41 sec | 42 sec | 46 sec | 43 sec | 45 sec | 48 sec |
| for 5 samples | | | | | | |
| Afterflame time after | 13 sec | 12 sec | 15 sec | 14 sec | 15 sec | 16 sec |
| second flame | | | | | | |
| application | | | | | | |
| Afterflame or afterglow | No | No | No | No | No | No |
| up to holding clamp | | | | | | |
| Cotton indicator ignited | No | No | No | No | No | No |
| by flaming particles or | | | | | | |
| drops | | | | | | |
| Rating | V0 | V0 | V0 | V0 | V0 | V0 |

### INDUSTRIAL APPLICABILITY

The present invention is characterized in that the flame retardancy is conferred to a resin (particularly, HIPS/PPE) which has been made flame retardant using the halogen-based flame retarder in most cases, by using the non-halogen flame retardancy-imparting component, and thereby the resin component which applies a reduced environmental load and has high industrial value, is obtained. The resin composition of present invention is thus suitable for constituting various articles and useful as a material constituting, particularly exterior bodies of electric appliances and so on.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A resin composition which comprises one or more resin components and one or more metal sulfides as a flame retardancy-imparting component in an amount of from 5 wt % to 30 wt % of the resin composition, and does not comprise a phosphorus-based flame-retarder.

16. The resin composition according to claim 15 which comprises one or more sulfides of one or more metals selected from molybdenum, nickel, zinc, and cobalt, as the metal sulfide.

17. The resin composition according to claim 16, wherein the metal sulfide is molybdenum disulfide.

18. The resin composition according to claim 15 which comprises a styrene-based polymer as at least one said resin component.

19. The resin composition according to claim 18, wherein the styrene-based polymer is a high-impact polystyrene.

20. The resin composition according to claim 19 which further comprises polyphenylene ether as the resin component.

21. A molded body which is formed from the resin composition according to claim 15.

22. A method for producing a resin composition which does not comprise a phosphorous-based flame retarder, which method comprises kneading one or more resin components and one or more metal sulfides as at least one flame retardancy-imparting component in an amount of from 5wt % to 30 wt % of the resin composition.

23. A method for molding a resin composition which method comprises molding a composition which does not comprise a phosphorous-based flame retarder and is obtained by kneading one or more resin components and one or more metal sulfides as at least one flame retardancy-imparting component in an amount of from 5 wt % to 30wt % of the resin composition.

24. The resin composition according to claim 17 which comprises a styrene-based polymer as at least one said resin component.

25. The resin composition according to claim 24, wherein the styrene-based polymer is a high-impact polystyrene.

26. The resin composition according to claim 25 which further comprises polyphenylene ether as the resin component.
